(19) United States
(12) Patent Application Publication
(10) Pub. No.: US 2006/0125950 A1
(43) Pub. Date: Jun. 15, 2006

(54) Digital camera module with a focusing assembly

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/240,230

(22) Filed: Sep. 30, 2005

(30) Foreign Application Priority Data
Dec. 10, 2004 (CN) 200410077478.0

(51) Int. Cl. G03B 13/00; H04N 5/232

(52) U.S. Cl. 348/345

(57) ABSTRACT

A focusing assembly (10) includes a holder (11), a voice coil actuator (20), a rotating tube (23), and an inner tube (31). The holder is covered by a cover (12) and has a guiding slot (112) defined therein. The rotating tube is received in the holder and includes a magnet element (21) fixed to an inner surface of the holder. A coil (22) is located in the magnetic field of the magnet element. The coil is wound on the outside of the rotating tube, which further has an internal thread (231) inside. The inner tube receives an image sensor (32) inside and has an external thread (311) outside screwed with the internal thread of the rotating tube. The inner tube, wound with the coil, rotates in reaction to the magnet element when a current is flowed through the coil, and the guiding block, coupled with the guiding slot, limits the axial movement of the inner tube and thereby offers thrust reversal to the inner tube in telescopic movement.

### BACKGROUND OF THE INVENTION

1. Field of the Invention

The present invention relates generally to a digital camera module with a focusing assembly and, more particularly, to a small sized digital camera module with the focusing assembly mounted in a portable electronic device such as a mobile phone or a Personal Digital Assistant (PDA).

2. Discussion of the Related Art

Recently, with the development of wireless communication technologies, there are many cases where digital cameras are mounted in mobile phones or PDAs.

Generally, digital cameras are image recording media capable of photographing a plurality of still images without using film. Such a digital camera typically uses an image pickup device, which is a kind of semiconductor device, such as a Charge Coupled Device (CCD) or Complementary Metal Oxide Semiconductor (CMOS). In the digital camera, an object image formed on the image pickup device through a lens is converted into an electrical signal by the image pickup device, and the electrical signal is stored as a digital signal in a mobile phone or PDA in which the digital camera is mounted.

Since the digital camera is desirably to be mounted in small mobile phones or PDAs, a fixed focus lens module is usually used to facilitate mounting thereof within a small phone or PDA. However, images photographed by a digital camera module with a fixed focus lens module tend to be poor in quality. It is partly due to the fixed focus lens, which is incapable of adjusting focal length to make a clearer image.

A conventional digital camera with a focusing function usually uses an actuator such as step motor to drive the lens module. But the digital camera using such a step motor is relatively large in volume and consumes a substantial amount of power, especially relative to the amount of power that can be stored in the typical battery system of a mobile phone or PDA. As such, a step motor is not suitable to be used in mobile phone or PDA, which needs to be small and power saving.

What is needed, therefore, is a digital camera module with a focusing assembly which satisfies the needs for performance enhancement, downsizing and power saving.

### SUMMARY OF THE INVENTION

In a preferred embodiment, a focusing assembly for a camera module includes a holder, a voice coil actuator, a rotating tube, and an inner tube. The holder is covered by a cover and has a guiding slot defined therein. The rotating tube is received in the holder and includes a magnet element fixed to an inner surface of the holder. A coil is located in the magnetic field of the magnet element. The rotating tube has the coil wound on the outside thereof, and the rotating tube further has an internal thread inside. The inner tube receives an image sensor inside and has an external thread outside thereof screwed with the internal thread of the rotating tube. The inner tube wound with the coil rotates in reaction to the magnet element when the coil is flowed/moved past a current flow. The guiding block, coupled with the guiding slot, limits the axial movement of the inner tube and offers thrust reversal to the inner tube in telescopic movement.

Other advantages and novel features will become more apparent from the following detailed description of preferred embodiments when taken in conjunction with the accompanying drawings.

### BRIEF DESCRIPTION OF THE DRAWING

Many aspects of a digital camera module with a focusing assembly can be better understood with reference to the following drawing. The components in the drawing are not necessarily to scale, the emphasis instead being placed upon clearly illustrating the principles of the digital camera module with a focusing assembly. Moreover, in the drawing, like reference numerals designate corresponding parts throughout the several views.

FIG. 1 is a schematic, cross-sectional view of a digital camera module with a focusing assembly according to a preferred embodiment of the present invention.

### DETAILED DESCRIPTION OF THE PREFERRED EMBODIMENT

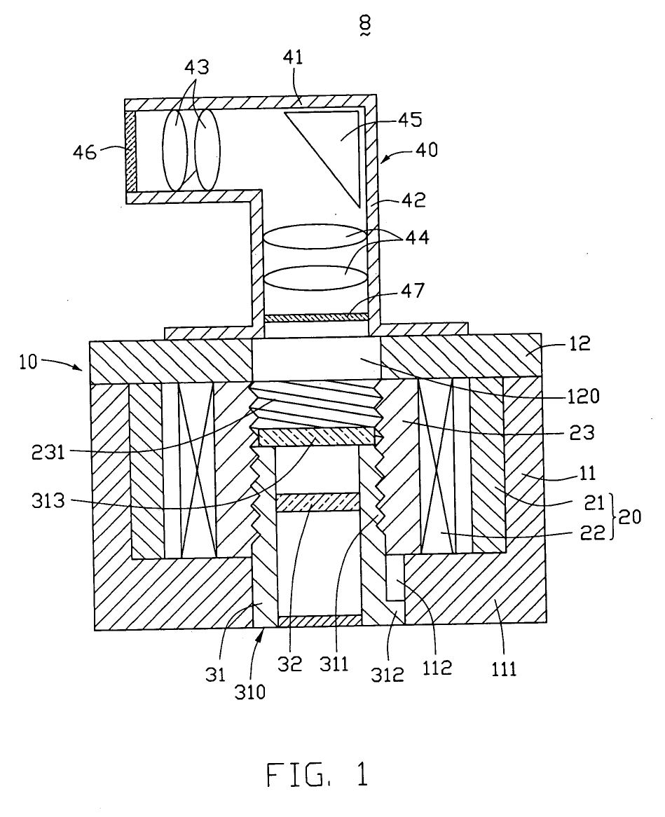

Referring to FIG. 1, a digital camera module 8 with a focusing assembly 10, in accordance with a preferred embodiment of the present invention, is shown. The digital camera module 8 includes the focusing assembly 10 and a lens module 40. The focusing assembly 10 receives an image sensor 32 therein and can change the position of the image sensor 32 when focusing. The lens module 40 is fixed to the focusing assembly 10 and is capable of routing the input light beams to the image sensor 32.

The focusing assembly 10 includes a holder 11, a voice coil actuator 20, a rotating tube 23, and an inner tube 31.

The holder 11 is a half-opening hollow cylinder and defines a receiving cavity (not labeled) inside. A holder bottom 111 is disposed at one end of the holder 11 and defines an opening (not labeled) in the center thereof. The opening is in communication with the receiving cavity of the holder 11. A guiding slot 112 is defined in a direction of the axis of the holder 11 on the inner surface of the holder bottom 111. A cover 12 is attached to the other end opposite to the bottom 111 of the holder 11. The cover 12 is either transparent or has a cover hole 120 defined in the central portion thereof so that light beams can be transmitted therethrough.

The voice coil actuator 20 is received by the holder 11 and includes a magnet element 21 and a coil 22. Coil 22 is wound around an outside of the rotating tube 23. The magnet element 21 adopts a four-pole-piece design and includes four permanent magnets which are fixed to an inner surface of the holder 11. The rotating tube 23 has an internal thread 231 formed inside thereof. The rotating tube 23 is axially located in the receiving cavity of the holder 11 and is incapable of moving axially since it is restricted by the cover 12 and the bottom 111 of the holder 11.

The inner tube 31 has a tube bottom 310 at one tube end and has an external thread 311 on the outside thereof. The external thread 311 of the inner tube 31 corresponds to the internal thread 231 of the rotating tube 23. A guiding block 312, corresponding to the guiding slot 112 of the holder 11, protrudes from a surface outside the inner tube 31 near the tube bottom 310. The image sensor 32 is received in the inner tube 31. A transparent board 313 covers an end opposite the tube bottom 310 of the inner tube 31, in order to protect the image senor 32 from external pollution or contamination. The inner tube 31 is placed in and engages with the rotating tube 23, and the guiding block 312 couples with the guiding slot 112 of the bottom 111 of the holder 11.

The lens module 40 is attached on the cover 12 of the focusing assembly 10. The lens module 40 includes a first barrel 41, a second barrel 42, and a reflecting element 45. The first barrel 41 is covered by a glass board 46 and receives a first lens group 43 therein. The second barrel 42 receives a second lens group 44 and an Infra-red (IR) cut filter 47 therein. The first barrel 41 connects and subtends an angle, such as 90 degrees in the preferred embodiment, with the second barrel 42. The reflecting element 45 is located at the connecting area between the first barrel 41 and the second barrel 42. The reflecting element 45 can reflect the light beams transmitted sequentially through the glass board 46 and the first lens group 43 on to the second lens group 44.

In assembling the focusing assembly 10, firstly, the magnet element 21 is fixed to the inner surface of the holder 11. Secondly, the inner tube 31, receiving the image sensor 32 therein, is inserted in the holder 11 from the opening of the holder bottom 111. The guiding block 312 is correspondingly coupled with the guiding slot 112 of the bottom 111. Thirdly, the rotating tube 23, wound with the coil 22, is screwed on the inner tube 31 until the rotating tube 23 is totally received by the receiving cavity of the holder 11. Then, the opening of the holder 11 is covered by the cover 12. After assembling the focusing assembly 10, the lens module 40 is affixed on the cover 12, making sure that the optical axis of the second lens group 44 is in alignment with the optical axis of the image sensor 32.

In use, the camera module 8 with a focusing assembly 10 is equipped within a portable electronic device, such as mobile phone, and the coil 22 of the voice coil actuator 20 is electrically connected with a circuit board of the mobile phone for capturing electrical power. When the coil 22 is induced with a current flow, the coil 22 generates a magnetic filed. Since the coil 22 is located in the magnetic field of the magnet element 21, the rotating tube 23 (wound with the coil 22) rotates in reaction to the magnet element 21. The guiding block 312 coupled with the guiding slot 112 reacts to the internal thread 231 of the rotating tube 23, thereby resulting in stable telescopic movement of the inner tube 31 with the external thread 311. Thus, the focusing purpose is achieved by changing the distance between the image sensor 32 and the lens module 40.

It is to be understood that, alternatively (embodiment not illustrated) the inner tube 31 could receive a lens group and an IR cut filter therein, while the image sensor 32 would be fixed to the bottom 111 of the holder 11 in the light path of the lens group. Thus, the distance between the lens group of such an embodiment and the image sensor 32 could be changed by the telescopic inner tube 31 to implement the focusing purpose.

In addition, the camera module 8 with the focusing assembly 10 can further include a position sensor (not shown) electrically connected both with the image sensor 32 and a microprocessor unit (MPU) of the mobile phone. The position sensor would detect the image definition formed on the image sensor 32 and would transmit the definition information to the MPU. The MPU would then control switching of the coil 22 to a power-on or power-off state basing on the definition information. Thus, the camera module could implement an automatic focusing function.

In the preferred embodiment, it is of advantage that the voice coil actuator 20 is so compact that the digital camera module 8 with the focusing assembly 10 can be miniaturized enough to be combined with the portable electronic device. Of further advantage, the voice coil actuator 20 needs relatively little power to drive the image sensor 32, so it is power saving. In addition, as the image sensor 32 moves in the direction of the axis, there is not any rotation thereof relative to the lens module 40. Thus, the image sensor 32 is always in alignment with the optical axis of the lens module 40.

It is believed that the present embodiment and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A focusing assembly, pertaining to portable electronic devices, comprising:
a holder which is a cylinder portion, the holder having a holder opening and a holder inner surface, the holder comprising:
a cover covering the opening of the holder; and
a guiding slot defined in the inner surface of the holder;
a voice coil actuator received in the holder, the voice coil actuator comprising:
a magnet element fixed to the inner surface of the holder, the magnet element having a magnetic field associated therewith; and
a coil located in the magnetic field of the magnet element;
a rotating tube received in the holder, the rotating tube having an internal thread and a tube outside, the coil being wound on the tube outside; and
an inner tube receiving an image sensor therein, the inner tube having an external thread outside, the external thread being screwed with the internal thread of the rotating tube, the inner tube further comprising:
a guiding block protruding from an outside surface of the inner tube, the guiding block being coupled with the guiding slot of the holder.

2. The focusing assembly as claimed in claim 1, wherein the magnet element comprises an adopted four-magnet, four-pole piece design.

3. The focusing assembly as claimed in claim 1, wherein the holder further has a bottom in an opposite end to the covering, and the bottom has a hole defined in the center thereof.

4. The focusing assembly as claimed in claim 3, wherein the guiding slot communicates with the hole in the bottom.

5. The focusing assembly as claimed in claim 1, wherein the cover is transparent.

6. The focusing assembly as claimed in claim 1, wherein the cover defines a hole in the center thereof.

7. The focusing assembly as claimed in claim 1, wherein the inner tube further comprises a transparent board, the transparent board covering and closing an inner tube end.

8. A digital camera module with a focusing assembly comprising:
a focusing assembly comprising:
a holder which is a cylinder portion, the holder having a holder opening and a holder inner surface, the holder comprising:
a cover covering the opening of the holder; and
a guiding slot defined in the inner surface of the holder;
a voice coil actuator received in the holder, the voice coil actuator comprising:
a magnet element fixed to the inner surface of the holder, the magnet element having a magnetic field associated therewith; and
a coil located in the magnetic field of the magnet element;
a rotating tube received in the holder, the rotating tube having an internal thread and a tube outside, the coil being wound on the tube outside; and
an inner tube receiving an image sensor therein, the inner tube having an external thread outside, the external thread being screwed with the internal thread of the rotating tube, the inner tube further comprising:
a guiding block protruding from an outside surface of the inner tube, the guiding block being coupled with the guiding slot of the holder; and
a lens module attached to the focusing assembly and capable of routing light beams to the image sensor of the focusing assembly, the lens module including at least one lens groups therein;
wherein the coil is configured for rotating in reaction to the magnet element when a current is flowed through the coil, the guiding block being coupled with the guiding slot so as to thereby limit axial movement of the inner tube and to thereby offer thrust reversal to the inner tube in telescopic movement.

9. The digital camera module with a focusing assembly as claimed in claim 8, wherein the lens module comprises a first barrel and a second barrel, the second barrel connecting with and subtending at an angle to the first barrel.

10. The digital camera module with a focusing assembly as claimed in claim 9, wherein the lens module further comprises a reflecting element located at a connecting area between the first barrel and the second barrel, the reflecting element being capable of routing light beams to the image sensor.

11. The digital camera module with a focusing assembly as claimed in claim 8, wherein the magnet element comprises an adopted four-magnet, four-pole piece design.

12. The digital camera module with a focusing assembly as claimed in claim 8, wherein the holder further has a bottom in an opposite end to the covering, and the bottom has a hole defined in the center thereof.

13. The digital camera module with a focusing assembly as claimed in claim 12, wherein the guiding slot communicates with the hole in the bottom.

14. The digital camera module with a focusing assembly as claimed in claim 8, wherein the cover is transparent.

15. The digital camera module with a focusing assembly as claimed in claim 8, wherein the cover defines a hole in the center thereof.

16. The digital camera module with a focusing assembly as claimed in claim 8, wherein the inner tube further comprises a transparent board, the transparent board covering and closing an inner tube end.
